(19) United States
(12) Patent Application Publication
(10) Pub. No.: US 2011/0094142 A1
(43) Pub. Date: Apr. 28, 2011

(54) Rubber decoy anchor

(76) Inventor: Charles D. Ayers, Denver, CO (US)

(21) Appl. No.: 12/589,425

(22) Filed: Oct. 23, 2009

(51) Int. Cl. A01M 31/06; B63B 21/50

(52) U.S. Cl. 43/3; 114/294

(57) ABSTRACT

A rubber decoy anchor including a truncated cone shaped base with a major floor section and a minor floor section; and a loop structure having two parallel linear segments connected at a first end to an end of an arched section and at a second end to an outer portion of the major floor section of the base.

### TECHNICAL FIELD

The present invention generally relates to waterfowl hunting decoys, and more particularly, to anchors for waterfowl hunting decoys.

### BACKGROUND

In the pursuit of waterfowl flying over locations that provide hunting opportunities, such as small streams, rivers, flooded fields or lakes, the waterfowl hunter requires durable and versatile equipment. One essential item for a hunter is a decoy anchor that secures a floating waterfowl decoy in position at a hunting location with a proper length of anchor line running from the decoy to the decoy anchor. To perform effectively, the decoy anchor must meet two requirements. First, it must be heavy enough to sink to the bottom of a body of water and maintain its position. This requires that the anchor have a specific gravity greater than that of water, which is 1.0. Secondly, it must be capable of being used in the various locations where waterfowl hunting opportunities exist. Therefore, the anchor must perform equally well in a stream or a river with current as it would in a flooded field or lake with wind and/or wave action.

The most commonly available prior art waterfowl decoy anchors do not provide the versatility needed and also presented additional problems. First, they are made from metals, and typically lead, having specific gravities ranging from 3.9 to 11.34, which makes them excessively heavy. These metal materials also degrade, deform and are known environmental contaminates. Second, these materials are capable of damaging the appearance of the waterfowl decoy with rust stains that degrade the painted finish of the decoy, and/or puncture or dent the decoy, rendering it incapable of floating properly. Third, they are designed for site specific locations and conditions, which limits their versatility. Fourth, and finally, they do not incorporate a means of neatly and conveniently storing the decoy anchor line in a manor that allows for quick and orderly pick up and deployment of the decoy. They require the hunter to either purchase additional unnecessary equipment, or to rap the anchor line around the decoy itself, which eventually degrades the finish of the decoy.

### SUMMARY

The novel waterfowl decoy anchor of the present invention incorporates the requirements a mobile and versatile hunter needs. The novel design has a curved bottom that encourages and permits the anchor to tilt over on an edge of the curved bottom. This edge enables the anchor to dig into the bottoms on which it rests to hold it in place in any location where exterior force would otherwise cause the waterfowl decoy to move. By incorporating an anchor line loop from one side of the anchor to the other also provides a place to quickly and orderly rap the anchor line around and the means by which the anchor and the wound anchor line can be slipped over the head and around the neck of the decoy for convenient and organized storage of the anchor and anchor line. This eliminates some of the problems, but an environmental friendly anchor substance that will not damage the decoy or the environment is also needed.

In testing completed to date, the novel waterfowl decoy anchor of the present invention has been made from rubber and, more specifically, a Columbia Engineered Rubber compound CP-EP50-9006, which has a specific gravity of 1.40+/−0.02. Among its many attributes, rubber was found to be abrasion resistant and would not deform or degrade. It is non-marking and will not stain. It can have a sufficiently high specific gravity to be heavy enough to sink properly yet light enough for transporting easily. It has a compression set value providing strength, yet is flexible enough to not damage a waterfowl decoy. It is O-Zone resistant and environmentally friendly.

One embodiment of the present invention is a rubber decoy anchor comprising: a truncated cone shaped base with a major floor section and a minor floor section; and a loop structure having two parallel linear segments connected at a first end to an end of an arched section and at a second end to an outer portion of the major floor section of the base.

Another embodiment of the present invention is a rubber decoy anchor comprising: a truncated cone shaped base with a support structure; and the support structure having a means for positioning the support structure over a portion of a decoy; a means for attaching a line to the support structure; and a means for securing the line around the support structure for storage.

Yet another embodiment of the present invention is an apparatus comprising: a decoy with a rubber decoy anchor having a truncated cone shaped base with a major floor section and a minor floor section and a loop structure having two parallel linear segments connected at a first end to an end of an arched section and connected at a second end to an outer portion of the major floor section of the base; and a line attached to the decoy and the anchor; where the anchor is utilized to retain the decoy in a set position; where the line is capable of being secured around the loop structure of the anchor; and where the arched section of the loop structure with the line secured is capable of being positioned around a portion of the decoy.

### BRIEF DESCRIPTION OF THE FIGURES

FIG. 1 is a perspective view of an embodiment of a decoy anchor of the present invention.

FIG. 2 is a front view of the embodiment shown in FIG. 1.

FIG. 2a is a front view of the embodiment shown in FIG. 1 with the line secured.

FIG. 3 is a front view of an embodiment of the present invention.

FIG. 4a is a side view of an embodiment of the present invention.

FIG. 4b is a side view of another embodiment of the present invention.

FIG. 5 is an embodiment of the present invention engaged with a body of water and attached by a line to a decoy.

FIG. 6 is an embodiment of the present invention with the line secured and positioned on a decoy.

### DETAILED DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

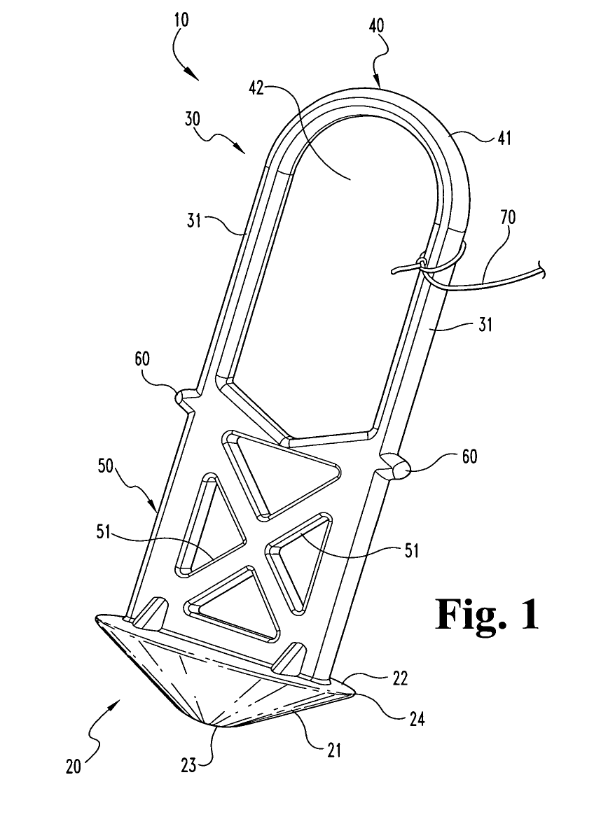

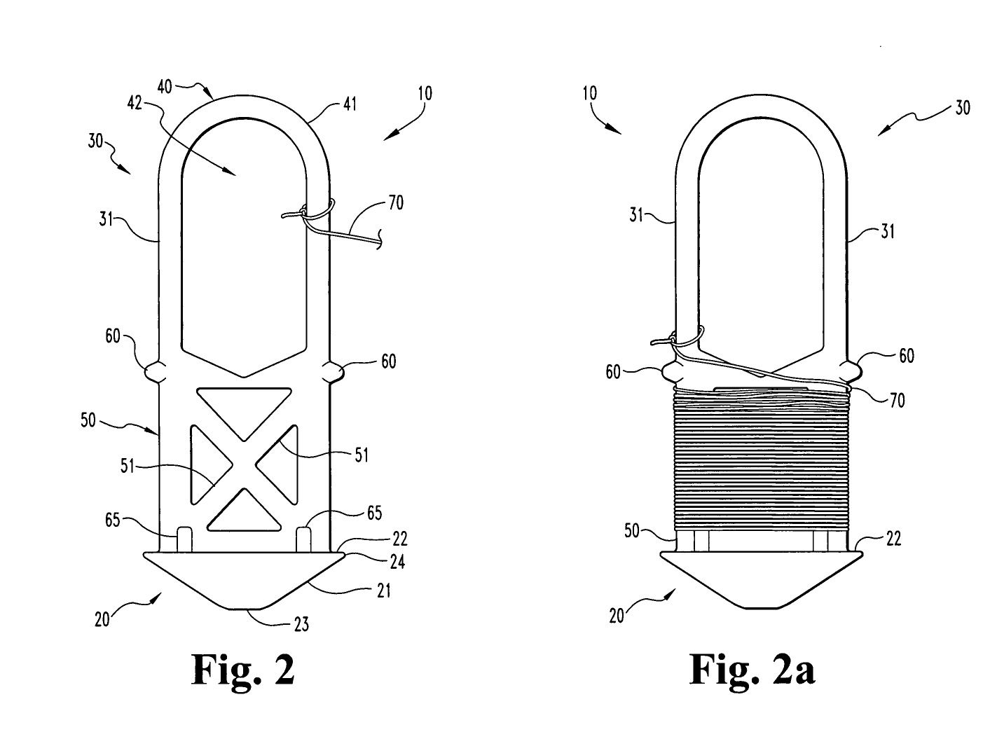

With reference to FIGS. 1 and 2, the rubber anchor system 10 of the present application includes two sections: a base section 20 and a loop structure section 30. The base section 10 includes a base in the general shape of a cone. In one embodiment, the base may be in the shape of a truncated cone with a conical surface 21, a major floor section 22, and a minor floor section 23.

The slope of the conical surface 21 should be sufficient enough to allow for an adequate major floor section 22. One embodiment with a slope of the conical surface 21 and the major floor section 22 profile is shown in FIG. 2. Another embodiment with a variation of the major floor section 422 profile is shown in FIG. 4a where the major floor section 422 may be non-level or concave. FIG. 4a shows the non-level major floor section 422 in phantom. Yet another embodiment with a variation of the slope of the conical surface 421 is shown in FIG. 4b.

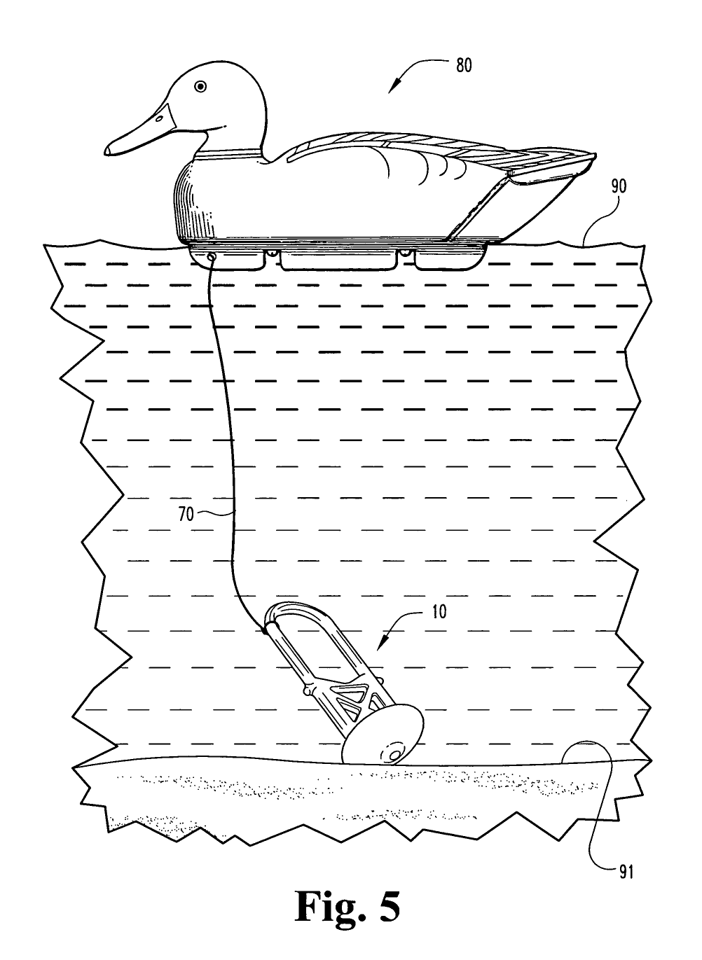

The major floor section 22 needs a sufficient area to maintain the position of the rubber anchor 10 without creating an anchor with a weight to cumbersome to transport, store and use. The slope of the conical surface 21 must also be sufficient enough to encourage and permit the rubber anchor 10 to tilt over on a leading edge 24 as shown in FIG. 2. The leading edge 24 of the major floor section 22 makes the rubber anchor 10 capable of digging into the bottom surface 91 of a body of water 90, as one embodiment is shown in FIG. 5, thereby holding the decoy 80 in a set position when exterior forces would cause the decoy to move.

Returning to FIG. 2, the loop structure 30 of the rubber anchor 10 includes a loop portion 40 and a structure portion 50. A loop from one side of the rubber anchor 10 to the other provides a place to quickly and orderly wrap the line 70 around the rubber anchor 10. The loop structure 30 of the rubber anchor 10 can then be slipped over a portion of the decoy for convenient and organized storage.

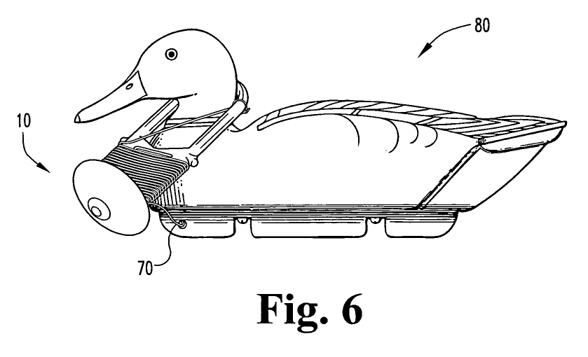

In the embodiment show in FIG. 2, the loop portion 40 includes an arched portion 41 and an inner surface portion 42. When the rubber anchor 10 is placed over a portion of a decoy for storage, the portion of the decoy passes through the inner surface portion 42 and the arched portion 41 engages the decoy. In one embodiment, the decoy is in the shape of a duck. The loop portion 40 then allows the rubber anchor 10 to be placed over the head and stored around the neck of the duck decoy 80 as shown in FIG. 6.

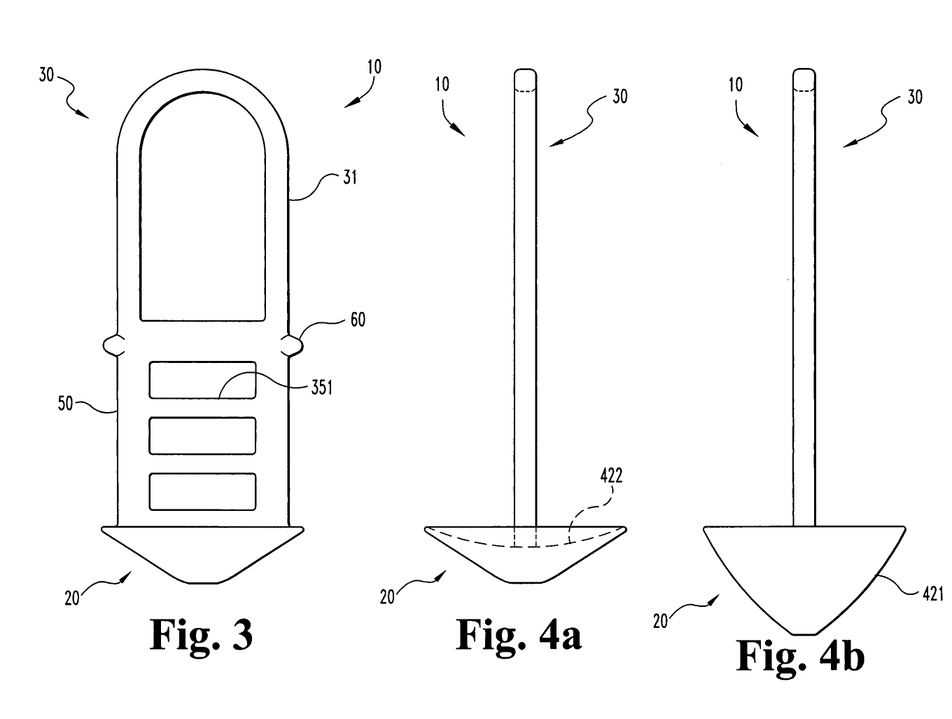

Two parallel linear members 31 extend from the arched portion 41 of the loop portion 40 to the structure portion 50. The structure portion 50 provides a location for securing the line 70 during storage and providing additional structural support to the rubber anchor 10. Additional cross support in the structure portion 50 of the loop structure 30 is capable of adding stability and strength of the rubber anchor 10. If the line 70 is wrapped too tightly around the loop structure 30, the cross support would keep the loop structure 30 from compressing. The cross supports also add additional weight to the rubber anchor 10 without increasing the overall size. In the embodiment shown in FIGS. 1 and 2, the structure portion 50 includes cross support members 51 in the form of an X-pattern between the parallel linear members 31. The cross support members, as shown in FIG. 3, can also be linear support members 351 between the parallel linear members 31. The dimensions and pattern of the cross support members 51 can be varied by one skilled in the art to maintain structural support of the loop structure 30.

Other features can be added to improve the structural performance of the rubber anchor 10. The embodiment shown in FIG. 2 includes two protrusions 60. A protrusion 60 extends outward from each parallel linear member 31 of the loop structure 30. These protrusions 60 are designed to maintain the line 70 on the loop structure 30 when securing the line 70. One embodiment with a line 70 in the secured position is shown in FIG. 2a. The protrusions 60 help prohibit the line 70 from sliding up and off of the loop structure 30. In certain situations, the line 70 may move along the loop structure 30 due to hitting or catching on objects during use or storage or by water currents when not all of line 70 is released to set the decoy. The protrusions 60 can have rounded or squared edges and various geometries as would occur to one skilled in the art to facilitate maintaining the line 70. The height of the protrusions 60 would be determined by one skilled in the art to accommodate an adequate amount of the line 70 material.

As shown in the embodiment in FIGS. 1 and 2, reinforcing ribs 65 can be added to provide stability to the rubber anchor 10 at the point where the loop structure 30 attaches to the base structure 20. Reinforcing ribs 65 can be added at other locations and the design and position of the reinforcing ribs 65 can be varied by one skilled in the art to provide stability based on material selection and other physical parameters on the rubber anchor 10.

One embodiment includes a non-marking rubber material with a specific gravity within the range of 1.35 to 1.45. One specific example is the Columbia Engineered Rubber compound CP-EP50-9006. Among its characteristics are abrasion resistance, deformation or degradation resistance, non-marking, non-staining, ozone-resistant and environmentally friendly. CP-EP50-9006 has a specific gravity of 1.40+/−0.02 which is heavy enough to sink properly yet light enough for transporting easily. CP-EP50-9006 also has sufficient compression strength to handle the stresses of water movement but is flexible enough not to damage the decoy.

The anchor system can include a material other than rubber. The anchor material should have a specific gravity greater than 1.0 in reference to water in order for the anchor to sink. Selection of a material with a specific gravity slightly greater than 1.0 would produce an anchor that would perform properly without creating an anchor with a weight that is difficult to handle. A material can also be selected to prevent degradation and deformation of the anchor. Environmental contamination of the water bodies may also be a factor. Another factor in material selection is the prevention of damage to the decoy. Common anchor materials are capable of damaging the decoy with oxidation stains that degrade the painted finish. Physical damage can be caused by an anchor such as puncturing or denting the decoy thereby leaving it incapable of floating properly. Anchors made of materials that create the potential for oxidation stains and punctures or dents of the decoy should be avoided.

One aspect of the present application is a rubber decoy anchor including a truncated cone shaped base with a major floor section and a minor floor section; and a loop structure having two parallel linear segments connected at a first end to an end of an arched section and at a second end to an outer portion of the major floor section of the base.

Further variations include a line capable of connecting the loop structure to an object and capable of being secured around the loop structure and a reinforcing rib at a point where the parallel linear segments connect to the base. The loop structure can also include a set of protrusions positioned along an outer edge of the parallel linear segments where the protrusions define a space for positioning the line at a portion of the loop structure adjacent the base when the line is being secured. The loop structure may also include a system of support members connected between the parallel linear segments where the system is positioned adjacent the second end of the parallel segments.

Another embodiment may be a rubber decoy anchor including a truncated cone shaped base with a major floor section and a minor floor section; and a loop structure having two parallel linear segments connected at a first end to an end of an arched section and at a second end to an outer portion of the major floor section of the base made of a material with a non-marking characteristic and a specific gravity greater than 1.0.

Yet another embodiment may include a rubber decoy anchor including a truncated cone shaped base with a major floor section and a minor floor section; and a loop structure having two parallel linear segments connected at a first end to an end of an arched section and at a second end to an outer portion of the major floor section of the base and a decoy with an attachment point for connecting the decoy to a line that is connected to the loop structure.

A further embodiment includes a truncated cone shaped base with a support structure, and the support structure having a means for positioning the support structure over a portion of a decoy; a means for attaching a line to the support structure; and a means for securing the line around the support structure for storage.

Another embodiment includes an apparatus with a decoy; an anchor having a truncated cone shaped base with a major floor section and a minor floor section and a loop structure having two parallel linear segments connected at a first end to an end of an arched section and connected at a second end to an outer portion of the major floor section of the base; and a line attached to the decoy and the anchor where the anchor is utilized to retain the decoy in a set position, the line is capable of being secured around the loop structure of the anchor, and the arched section of the loop structure with the line secured is capable of being positioned around a portion of the decoy.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A rubber decoy anchor comprising:
a truncated cone shaped base with a major floor section and a minor floor section; and
a loop structure having two parallel linear segments connected at a first end to an end of an arched section and at a second end to an outer portion of the major floor section of the base.

2. The rubber decoy anchor of claim 1, further including a line capable of connecting the loop structure to an object and capable of being secured around the loop structure.

3. The rubber decoy anchor of claim 1, further including a reinforcing rib at a point where the parallel linear segments connect to the base.

4. The rubber decoy anchor of claim 2, the loop structure further including a set of protrusions positioned along an outer edge of the parallel linear segments wherein the protrusions define a space for positioning the line at a portion of the loop structure adjacent the base when the line is being secured.

5. The rubber decoy anchor of claim 4, the loop structure further includes a system of support members connected between the parallel linear segments and wherein the system is positioned adjacent the second end of the parallel segments.

6. The rubber decoy anchor of claim 1, further consisting of a material with a non-marking characteristic and a specific gravity greater than 1.0.

7. The rubber decoy anchor of claim 2, further including a decoy with an attachment point for connecting the decoy to the line which is connected to the loop structure.

8. A rubber decoy anchor comprising:
a truncated cone shaped base with a support structure; and
the support structure having
a means for positioning the support structure over a portion of a decoy;
a means for attaching a line to the support structure; and
a means for securing the line around the support structure for storage.

9. The rubber decoy anchor of claim 8, wherein the base and support structure further consist of a material with a non-marking characteristic and a specific gravity greater than 1.0.

10. An apparatus comprising:
a decoy;
a rubber decoy anchor having a truncated cone shaped base with a major floor section and a minor floor section and a loop structure having two parallel linear segments connected at a first end to an end of an arched section and connected at a second end to an outer portion of the major floor section of the base; and
a line attached to the decoy and the anchor;
wherein the anchor is utilized to retain the decoy in a set position;
wherein the line is capable of being secured around the loop structure of the anchor; and
wherein the arched section of the loop structure with the line secured is capable of being positioned around a portion of the decoy.

11. The apparatus of claim 10, wherein the anchor further includes a material with a non-marking characteristic and a specific gravity greater than 1.0.

12. The apparatus of claim 10, the loop structure further including a set of protrusions positioned along an outer edge of the parallel segments wherein the protrusions define a space for positioning the line at a bottom portion of the loop structure when the line is being secured.

13. The apparatus of claim 10, the loop structure further includes a system of support members connected between the parallel segments and wherein the system is positioned adjacent the second end of the parallel segments.
